(19) United States
(12) Patent Application Publication
(10) Pub. No.: US 2018/0354322 A1
(43) Pub. Date: Dec. 13, 2018

(54) TONGUE JACK AND COUPLER ASSEMBLY

(71) Applicant: LIPPERT COMPONENTS, INC., Elkhart, IN (US)

(72) Inventors: Kaleb VanOrt, Granger, IN (US); Trenton Miller, Goshen, IN (US); Marc Grimes, Syracuse, IN (US)

(21) Appl. No.: 16/003,233

(22) Filed: Jun. 8, 2018

Related U.S. Application Data
(60) Provisional application No. 62/518,308, filed on Jun. 12, 2017.
(60) Provisional application No. 62/530,995, filed on Jul. 11, 2017.

(51) Int. Cl. B60D 1/40; B60D 1/66; B60S 9/04

(52) U.S. Cl. CPC B60D 1/40; B60D 1/465; B60S 9/04; B60D 1/66

(57) ABSTRACT

A system for connecting a tongue jack to a trailer coupler includes a coupler, a jack plate, and a lower plate. The coupler defines a slot configured to receive an outer tube of a tongue jack. The lower plate defines an aperture configured to receive and laterally restrain the outer tube of the tongue jack. The jack plate defines an aperture configured to receive and laterally restrain the outer tube of the tongue jack and a hanger configured to be received by the slot of the coupler and supported by the coupler adjacent the slot.

### CROSS-REFERENCE TO RELATED APPLICATIONS

This application claims benefit under 35 U.S.C. § 119 of U.S. Provisional Patent Application Nos. 62/518,308, filed on Jun. 12, 2017, and 62/530,995, filed on Jul. 11, 2017, and incorporates by reference the disclosures thereof in their entireties.

### BACKGROUND AND SUMMARY OF THE DISCLOSURE

A tongue jack for supporting the tongue of a trailer typically includes a telescoping assembly having an inner tube received within an outer tube and an operating mechanism for extending and retracting the inner tube from and to the outer tube. A jack plate typically is attached to the outer tube, for example, by welding. The jack plate typically defines three mounting holes configured for receiving mechanical fasteners that may be used to connect the tongue jack to a trailer coupler.

A trailer coupler typically includes a hitch ball-receiving portion and a frame-receiving portion configured for connection to a trailer frame. The frame-receiving portion typically includes a top plate defining a tube-receiving hole configured to receive the outer tube of the jack and three mounting holes configured to receive the foregoing mechanical fasteners.

Typically, the outer tube is inserted into the tube-receiving hole from above, and the jack plate is disposed atop the coupler top plate with the mounting holes of the jack plate aligned with the mounting holes of the coupler top plate. Mechanical fasteners may be inserted through the respective mounting holes to secure the jack plate to the coupler top plate.

With the jack plate atop the coupler top plate, the entirety of the tongue weight of the trailer coupler is in essence supported by the mechanical fasteners. As such, if the fasteners were to fail, the jack would no longer be capable of supporting the tongue of the trailer.

The present disclosure is directed to a jack plate and coupler for use with a tongue jack and trailer wherein the jack plate is disposed underneath the coupler top plate.

### BRIEF DESCRIPTION OF THE DRAWINGS

FIG. 1 is a perspective view of an illustrative tongue jack and trailer coupler assembly according to the present disclosure;

FIG. 2 is a perspective view of the trailer coupler of FIG. 1;

FIG. 3 is a perspective view of the tongue jack of FIG. 1;

FIG. 4 is a bottom plan view of the assembly of FIG. 1;

FIG. 5 is a bottom plan view of a portion of the assembly of FIG. 1;

FIG. 6 is a perspective view of a jack plate of the assembly of FIG. 1;

FIG. 7 is a perspective view of a lower plate of the assembly of FIG. 1;

FIG. 8 is a cross-sectional side view of the assembly of FIG. 1 without the tongue jack;

FIG. 9 is a perspective view of another illustrative tongue jack and trailer coupler assembly according to the present disclosure;

FIG. 10 is a cross-sectional side view of the assembly of FIG. 9;

FIG. 11 is a perspective view of the trailer coupler of FIG. 9;

FIG. 12 is a perspective view of a further tongue jack and trailer coupler assembly according to the present disclosure;

FIG. 13 is a perspective view of yet another illustrative tongue jack and trailer coupler assembly according to the present disclosure;

FIG. 14 is a perspective view of the trailer coupler of FIG. 13;

FIG. 15 is another perspective view of the trailer coupler of FIG. 13;

FIG. 16 is a perspective view of the tongue jack of FIG. 13 and a jack plate attached thereto; and

FIG. 17 is another perspective view of the tongue jack and jack plate of FIG. 13.

### DETAILED DESCRIPTION OF THE DRAWINGS

References to orientation herein, for example, upper, lower, top, bottom, front, rear, forward, rearward, left, right, vertical, horizontal, and the like, should be construed in the context of a trailer oriented normally on level ground in the direction the trailer would be pulled by a tow vehicle.

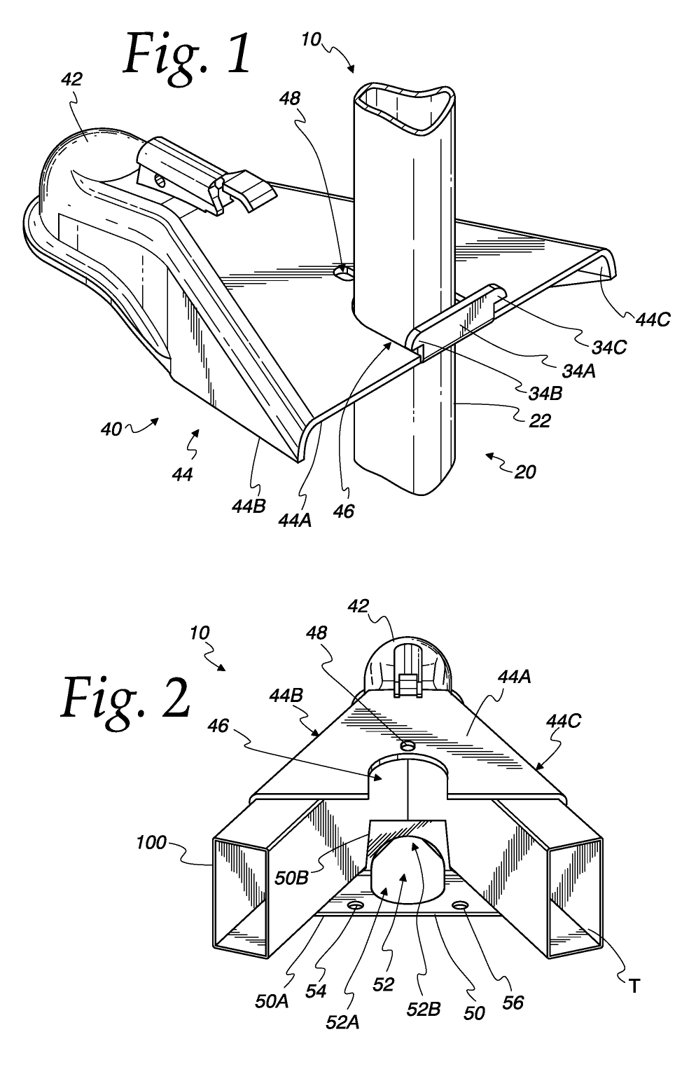

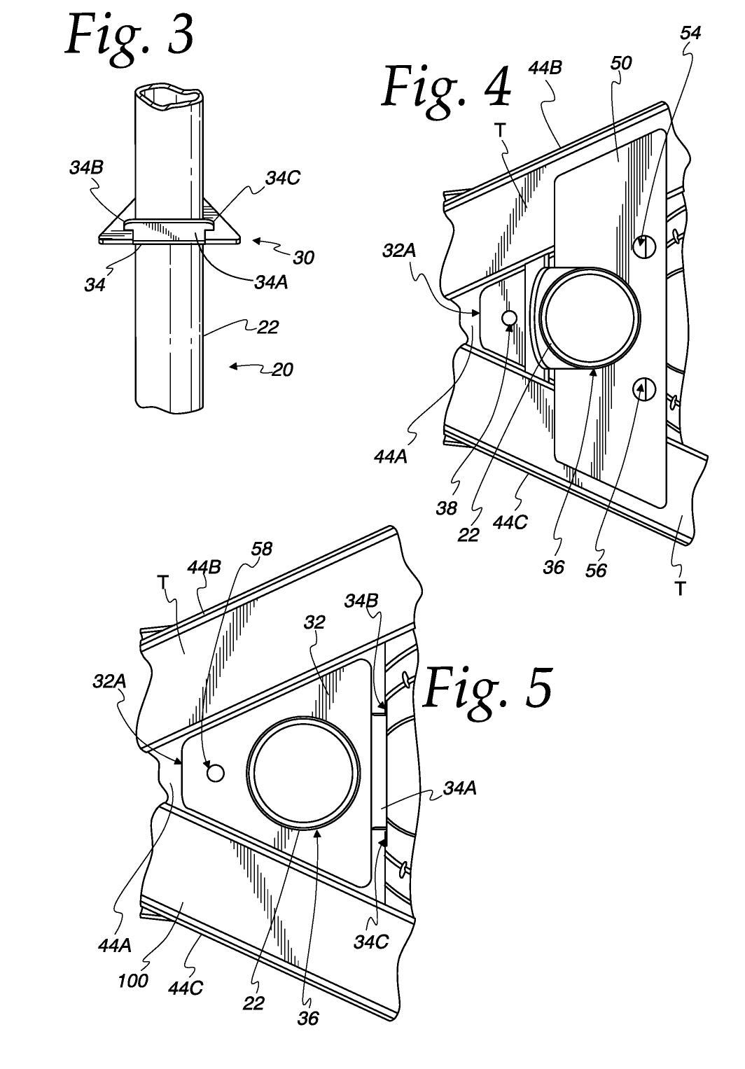

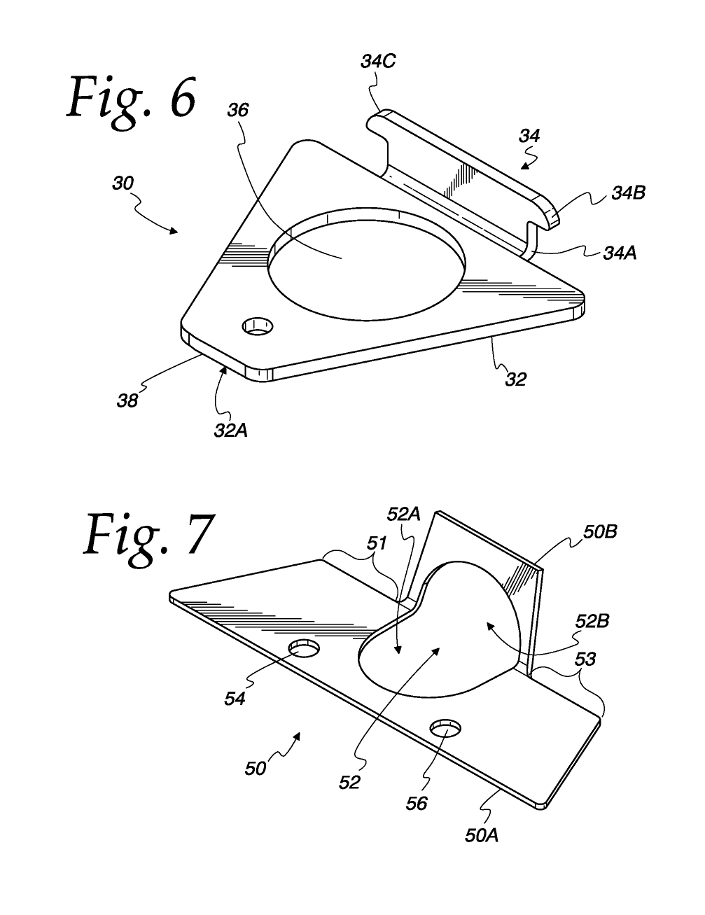

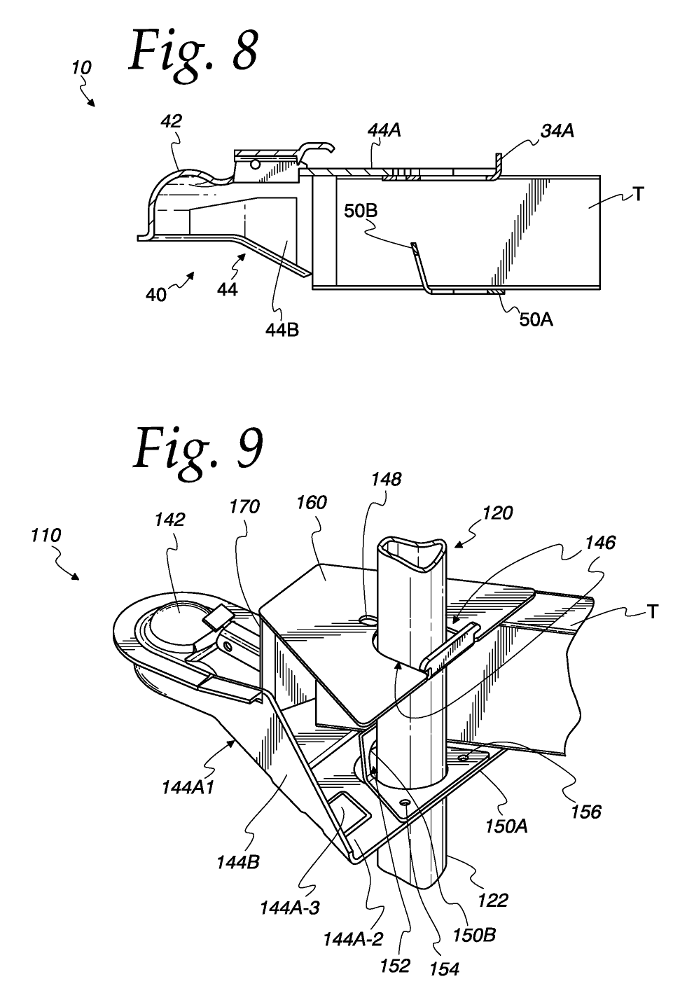

FIGS. 1-8 show an illustrative system 10 configured for attachment to a tongue (or drawbar) T of a trailer. The system 10 includes a tongue jack 20 attachable to a trailer coupler 40 via an intervening jack plate 30 connected to the tongue jack, typically by welding. The system 10 also includes a lower plate 50 (sometimes referred to herein as a jack lateral restraint plate) configured to constrain lateral motion of the tongue jack 20 when the system 10 is attached to the tongue T of the trailer. FIGS. 2, 4, and 5 further show the coupler 40 attached to the tongue T of a trailer frame.

The tongue jack 20 includes an elongated outer tube 22 having a generally cylindrical outer profile. The tongue jack 20 may also include an inner tube (not shown) telescopingly received with the outer tube and means (not shown) for telescopically extending the inner tube from, and retracting the inner tube into, the outer tube 22.

The jack plate 30 includes a base 32 (sometimes referred to herein as a jack-to-coupler transfer plate) and a hanger 34 extending generally perpendicularly upwardly from an edge of the base. The base 32 is configured as a truncated triangular plate defining a first aperture 36 configured to receive the outer tube 22 of the tongue jack 20 for welded attachment thereto. The base 32 also defines a second aperture 38 configured to receive a mechanical fastener (not shown), as will be discussed further below. The second aperture 38 may be located between the first aperture 36 and the truncated “corner” 32A of the base 32. The hanger 34 includes a stem 34A and first and second tabs 34B, 34C extending outwardly from opposite sides of the stem opposite the connection of the stem to the base. As such, the hanger 34 has a T-shaped profile.

The coupler 40 includes a ball-receiving portion 42 and a frame-receiving portion 44. The ball-receiving portion 42 may be conventional. The frame-receiving portion 44 includes a top plate 44A (sometimes referred to herein as a coupler-to-jack load transfer plate), a first (or left) side plate 44B depending from a first (or left) side of the top plate, and a second (or right) side plate 44C depending from a second (or right) side of the top plate. In a typical installation of the assembly 10 to the tongue T of the trailer frame, the top plate 44A may be generally horizontal, and the first and second side plates 44B, 44C may be generally vertical.

The top plate 44A, the first side plate 44B, and the second side plate 44C are configured for connection to an upper portion of the tongue T of the trailer frame. Such connection may be, for example, a bolted or welded connection.

The top plate 44A defines a rearward-facing, generally U-shaped slot 46 extending forwardly from a rear end of the top plate toward the ball-receiving portion 42. The slot 46 includes first (or left) and second (or right) generally linear side portions and a radiused portion connecting the first and second side portions. The slot 46 is configured to receive the outer tube 22 of the tongue jack 20, as will be discussed further below. The top plate 44A also defines an aperture 48 between the ball-receiving portion 42 and the slot 46. The aperture 48 is configured to receive a mechanical fastener (not shown), as will be discussed further below.

The lower plate 50 underlies and is connected to the bottom (or another lower portion) of the tongue T of the trailer frame. The lower plate 50 includes a generally planar and horizontal base 50A and a generally planar extension 50B extending at an angle upwardly from the base 50A. The base 50A defines a generally U-shaped slot 52A extending inwardly from a forward end thereof, and the extension 50B defines a generally U-shaped slot 52B extending upwardly from a lower end thereof. The slot 52A includes a radiused portion and may include first (or left) and second (or right) side portions connected by the radiused portion. Similarly, the second slot 52B includes a radiused portion and may include first (or left) and second (or right) side portions connected by the radiused portion. The open ends of the first and second slots 52A, 52B are coextensive so that the first and second slots 52A, 52B cooperate to define an eccentric aperture 52 through the bottom plate 50. The first and second slots 52A, 52B and the aperture 52 are configured to receive the outer tube 22 of the tongue jack 20, as will be discussed further below. The base 50A of the lower plate 50 may further define first and second apertures 54, 56, which may be sued to connect safety chains to the coupler 40. The base 50A of the lower plate 50 may include a first ear 51 extending outwardly from the first aperture 54 and a second ear 53 extending outwardly from the second aperture 56.

In use, the coupler 40 may be attached to the top or another upper portion of the tongue T of a trailer, for example, by welding one or more of the top plate 44A, the first side plate 44B, and the second side plate 44C to corresponding surfaces of the tongue T. Alternatively, the coupler 40 may be connected to the tongue T using mechanical fasteners (not shown). In such an embodiment, one or more of the top plate 44A, the first side plate 44B, and the second side plate 44C may be provided with apertures (not shown), and the tongue T may be provided with corresponding apertures (not shown) configured to receive such mechanical fasteners. The lower plate 50 may be similarly attached to the bottom or another lower portion of the tongue T.

The coupler 40 and the lower plate 50 may be attached to the tongue T so that the projection of the radiused portion of the slot 46 of the coupler and the projection of the radiused portion of the slot 52A of the base 50A of the lower plate 50, when viewed from above or below the coupler and the bottom plate, cooperate to generally define a circle having a generally vertical axis.

With the jack plate 30 connected, for example, welded, to the outer tube 22 of the jack 20, the lower end of the outer tube 22 of the tongue jack 20 may be inserted into the aperture 52 of the lower plate 50, for example, with the longitudinal axis of the outer tube at an angle to the generally vertical axis of the circle discussed above. The tongue jack 20 may then be pivoted, if necessary, to a vertical position in which the outer tube 22 and the stem 34A of the hanger 34 of the jack plate 30 are received within the slot 46 defined by the top plate 44A of the coupler 40, the base 32 of the jack plate 30 underlies the top plate 44A of the coupler 40, the hanger tabs 34B, 34C of the jack plate 30 overlie the top plate 44A of the coupler, and the aperture 48 of the top plate is axially aligned with the second aperture 38 of the jack plate. In an embodiment, the jack plate 30 may be configured so that the top plate 44A of the coupler 40 is received between the base 32 of the jack plate and the first and second ears 34B, 34C of the jack plate with little or no play in a direction perpendicular to the base 32.

A mechanical fastener (not shown) may be inserted through the aperture 48 of the top plate 44A and the aperture 38 of the jack plate 30 to secure the jack plate to the coupler 40. So assembled, the outer tube 22 of the tongue jack 20 may engage compressively with the inwardly-facing edges of the slot 46 of the coupler 40 and the slot 52A of the base 50A of the lower plate 50, thereby substantially precluding lateral motion of the tongue jack with respect to the coupler, the bottom plate, and the tongue T of the trailer. Also, with the tongue jack 20 deployed and bearing the weight of the tongue T of the trailer, the vertical component of the weight of the tongue is transferred from the tongue to the ground substantially via the jack plate 30 and the tongue jack, and substantially none of the vertical load is carried by the mechanical fastener connecting the jack plate to the coupler. With the tongue T of the trailer supported, for example, by a vehicle-mounted hitch, and the tongue jack 20 retracted, the weight of the tongue jack is transferred to the top plate 44A of the coupler 40 through the mechanical fastener and the ears 34B, 34C, stem 34, and base 32 of the jack plate 30.

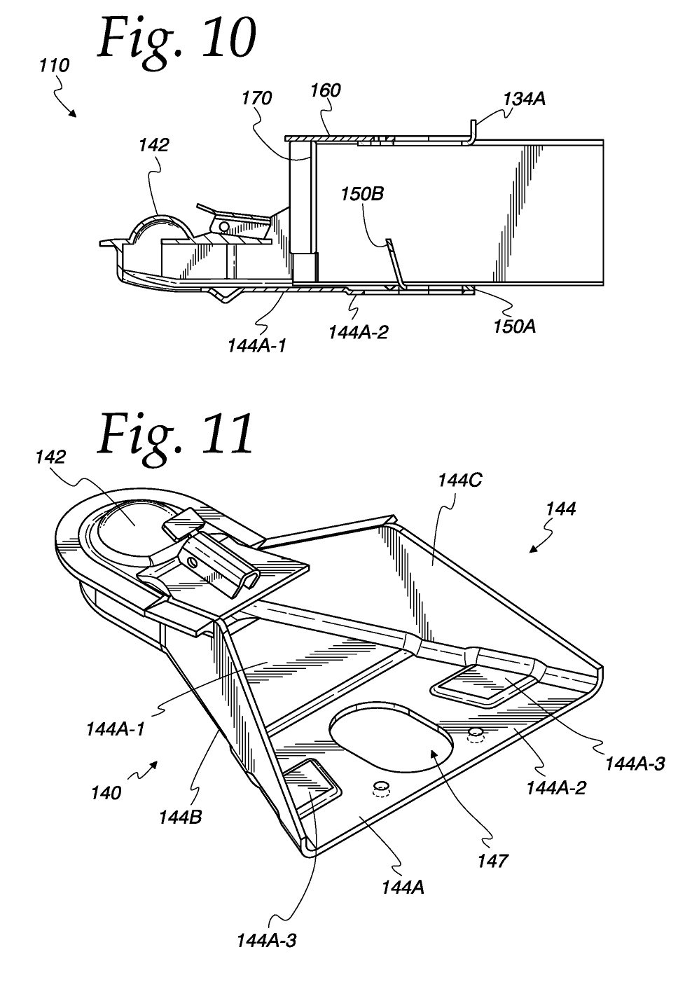

FIGS. 9-11 show another illustrative system 110 configured for attachment to a tongue T of a trailer. The system 110 is substantially similar to the system 10. As such the system 110 will be discussed herein primarily in terms of differences between it and the system 10. Features of the system 110 having counterparts in the system 10 may be referred to analogously herein and identified with like reference characters, incremented by 100.

The coupler 40 of the system 10 may be referred to as a top mount coupler because it is configured for mounting to the top (or another upper portion) of the tongue T of the trailer. The coupler 140 of the system 110 is instead configured for mounting to the bottom (or another lower portion) of the tongue T of the trailer. The coupler 140 includes a ball-receiving portion 142 and a frame-receiving portion 144. The frame-receiving portion 144 includes a bottom plate 144A, a first (or left) side plate 144B extending upwardly from a first (or left side) of the bottom plate, and a second (or right) side plate extending upwardly from a second (or right) side of the bottom plate. The bottom plate 144A includes a first (or forward) portion 144A-1 and a second (or rearward) portion 144A-2. The second portion 144A-2 is generally parallel to and downwardly offset from the first portion 144A-1. One or more pads 144A-3 may extend upwardly from the second portion 144A-2. An upper surface of the first portion 144A-1 may be generally coplanar with an upper surface of the pad(s) 144A-3. In an embodiment, the first and second portions 144A-1 and 144A-2 of the bottom plate 144A may be combined into a single, generally planar portion.

As best shown in FIG. 11, the bottom plate 144A defines an aperture 147. The aperture 147 is shown as an oval aperture including first (or left) and second (or right) side portions, and first (or forward) and second (or rearward) radiused portion connecting the first and second side portions. The aperture 147 is configured to receive the outer tube 122 of the tongue jack 120, as will be discussed further below. Alternatively, the aperture 147 is embodied as a rearward-facing slot (similar to the slot 46) extending inwardly from a rear portion of the bottom plate 144A toward the ball-receiving portion 142. In any event, the aperture 147 may be configured to restrain lateral side-to-side motion of the outer tube 122 of the jack 120 with respect to the bottom plate 144A of the coupler 140.

As shown, a lower plate 150 is connected to the bottom plate 144A of the coupler 140. The lower plate 150 is similar to the lower plate 50, except that the lower plate 150 may lack features analogous to the first and second ears 51, 53 of the lower plate 50.

The lower plate 150 may be welded to the bottom plate 144A of the coupler 140, for example, to the second portion 144A-2 of the bottom plate 144A of the coupler 140. Alternatively, the lower plate may define one or more apertures 154, 156, the bottom plate 144A of the coupler 140 may define one or more corresponding apertures, and mechanical fasteners may be used in connection with the apertures to connect the lower plate 150 to the bottom plate 144A. Such mechanical fasteners may also be used to connect safety chains to the coupler 140. If the bottom plate 144A includes one or more pads 144A-3 extending from the second portion 144A-2 thereof, the lower plate 150 may be disposed adjacent one or more such pads and/or between two or more such pads.

An upper plate 160 having a form similar to that of the top plate 44A of the coupler 40 is connected, for example, by welding, to the top (or another upper portion) of the tongue T of the trailer. The upper plate 160 defines a rearward-facing, generally U-shaped slot 146 extending inwardly from a rear end thereof toward a leading end thereof and configured in a manner similar to that of the slot 46 of the top plate 44A of the coupler 40. The upper plate 160 also defines an aperture 148 similar to the aperture 48 of the top plate 44A of the coupler 40.

The upper plate 160 and the coupler 140 (in combination with the lower plate 150) may be attached to the tongue T so that the projection of the radiused portion of the slot 146 of the upper plate 160 and the projection of the radiused portion of the slot 152A of the base 150A of the lower plate 150, when viewed from above or below the upper plate and the lower plate, cooperate to generally define a circle having a generally vertical axis.

A forward plate 170 may be connected between one or more of the tongue T, the upper plate 160, and the coupler 140.

The jack 20 with integral hanger 34 may be installed to the coupler 140, lower plate 150, and upper plate 160 of the system 110 in a manner similar to that describe above in connection with the system 10.

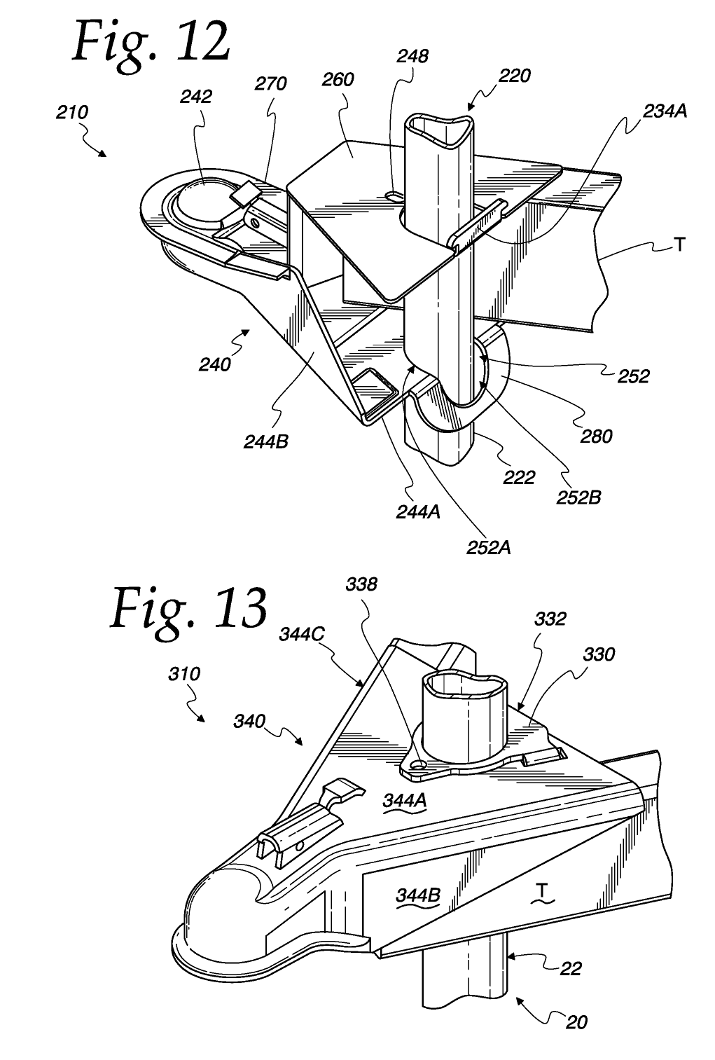

FIG. 12 shows a further illustrative system 210 configured for attachment to a tongue T of a trailer. The system 210 is substantially similar to the system 110. As such the system 210 will be discussed herein primarily in terms of differences between it and the system 110. Features of the system 210 having counterparts in the system 110 may be referred to analogously herein and identified with like reference characters, incremented by 100.

The bottom plate 244A of the coupler 240 is similar to the bottom plate 144A of the coupler 140 except that the bottom plate 244A may include a tab 280 extending downwardly from a rear end thereof. The tab 280 and the bottom plate 244A cooperate to define a slot 252, with a first portion 252A of the slot defined by the bottom plate and second portion 252B of the slot defined by the tab. The tab 280 is shown as integrally formed with the bottom plate 244A. This embodiment could, but need, not include a lower plate analogous to the lower plate 150. As shown, this embodiment does not include a lower plate analogous to the lower plate 150.

In an embodiment, the tab 280 could be embodied as a separate structure from the coupler 240 and attached thereto by welding, mechanical fasteners, or other suitable means. For example, the tab 280 could be embodied as a portion of a structure (not shown) similar to the lower plate 150, and the structure embodying the tab 280 could be connected to the bottom plate 244A of the coupler 240 in a manner similar to that in which the lower plate 150 is connected to the bottom plate 144A of the coupler 140.

The jack 220 with hanger 234 attached thereto may be installed to the coupler 240 and upper plate 260 of the system 210 in a manner similar to that described above in connection with the system 110.

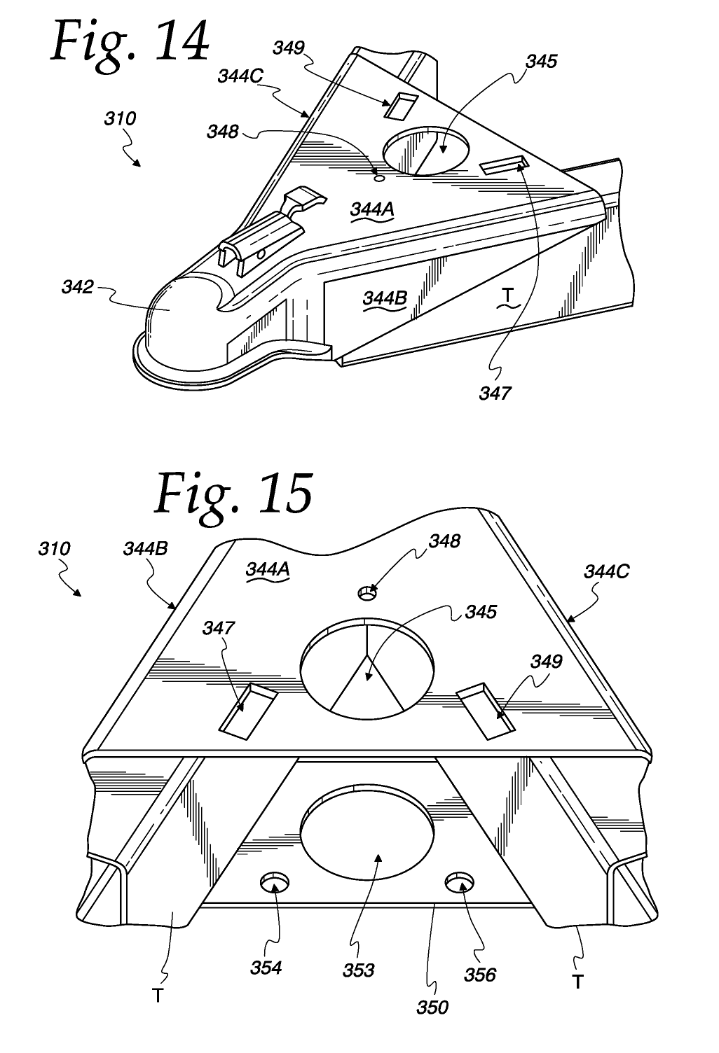

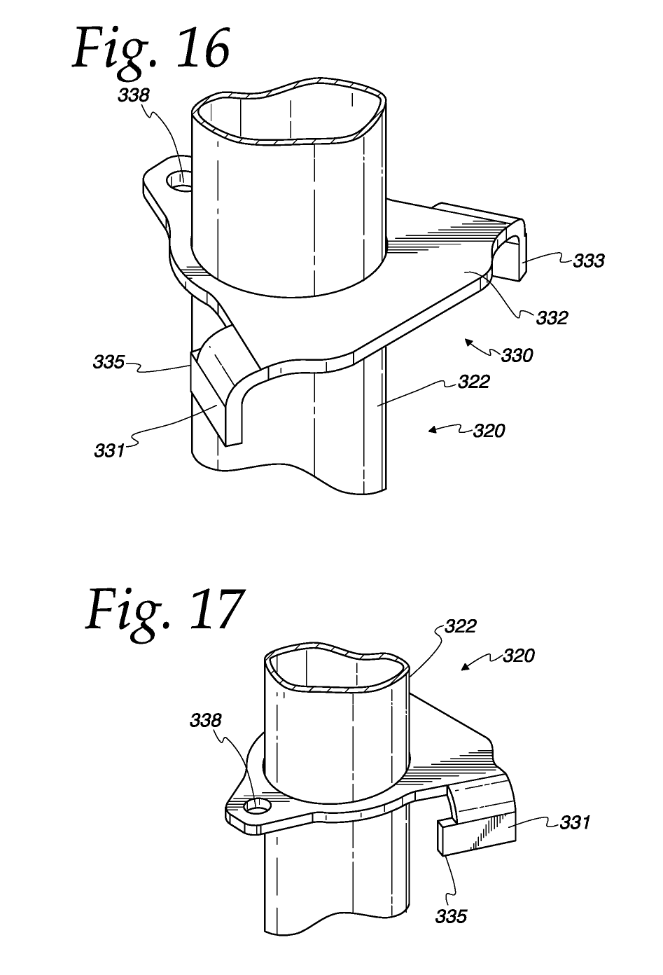

FIGS. 13-17 show another illustrative system 310 configured for attachment to a tongue T of a trailer. The system 310 is in many respects similar to the system 10. As such, the system 310 will be discussed herein primarily in terms of differences between it and the system 10. Features of the system 310 having counterparts in the system 10 may be referred to analogously herein and identified with like reference characters, incremented by 300.

Whereas the jack plate 30 of the system 10 includes a hanger 34 extending upwardly from the base 32 thereof, the jack plate 330 of the system 310 includes instead a first flange 331 extending downwardly from a first side or corner of a base 332 thereof and a second flange 333 extending downwardly from a second, opposing side or corner of the base thereof. Both the first flange 331 and the second flange 333 are opposite a first, jack receiving aperture 336 from a second, fastener-receiving aperture 338. A first tab 335 extends a first distance from an edge of the first flange 331, and a second tab 337 extends a second distance from a corresponding edge of the second flange 333. The first and second distances may, but need not be, the same. As shown, the first tab 335 and the second tab 337 are coplanar with the respective flanges 331, 333, and the first tab and the second tab extend generally forward from corresponding forward edges of the respective flanges. As such, the first tab 335 and the second tab 337 extend generally in the general direction of the portion of the jack plate 330 defining the second aperture 338. In another embodiment, the first tab 335 and the second tab 337 could extend generally rearward from corresponding rearward edges of the respective flanges 331, 333. In a further embodiment, the first tab 335 and the second tab 337 could extend generally laterally outwardly from corresponding lower edges of the respective flanges 331, 333.

Whereas the top plate 44A of the coupler 40 of the system 10 defines a slot 46 for receiving the outer tube 22 of the tongue jack 20, the top plate 344A (sometimes referred to herein as a jack load transfer plate) of the coupler 340 of the system 310 defines a jack-receiving aperture 345 for receiving the outer tube 322 of the tongue jack 320. The aperture 345 is configured to allow limited lateral fore and aft play of the outer tube 322 with respect to the top plate 344A, and to substantially preclude lateral side-to-side play of the outer tube with respect to the top plate, as will be discussed further below. The top plate 344A further defines a first slot 347 corresponding to the first flange 331 of the jack plate 330 and a second slot 349 corresponding to the second flange 333 of the jack plate. Each of the first and second slots 347, 349 is sufficiently long and wide to enable the corresponding first and second flange 331, 333, including the corresponding first and second tab, 335, 337, to be slidingly received therethrough and to enable sufficient displacement of the first and second tabs with respect to the top plate so that the first and second tabs may selectively engage with a lower surface of the top plate, as will be discussed further below.

The lower plate 350 (sometimes referred to herein as a jack lateral restraint plate) of the system 310 is a generally planar member defining a jack-receiving aperture 353. The aperture 353 is configured to receive the outer tube 322 of the jack 320 in sliding engagement therethrough with little or no lateral play in any direction. The lower plate 350 may also define first and second apertures 354, 356 that may be used to connect safety chains to the coupler 340.

In use, the coupler 340 and the lower plate 350 may be connected to the trailer tongue T, for example, as discussed above. With the jack plate 330 connected to the jack 320, the outer tube 322 of the jack may be slidingly received within the aperture 345 of the top plate 344A and the aperture 353 of the lower plate 350. With the jack 320 oriented so that the first and second flanges 331, 333 are aligned with the first and second slots 347, 349, respectively, the first and second flanges (including the first and second tabs 335, 337), may be received within the first and second slots. With the first and second flanges 331, 333 received within the first and second slots 347, 349, respectively, the jack 320 may be pitched forward with respect to the top plate 344A so that upper surfaces of the tabs 335, 337 become engaged with the lower surface of the top plate 344A adjacent to the first and second slots, and so that the second aperture 338 of the jack plate is coaxial with the 348 aperture of the top plate. A mechanical fastener (not shown) may be inserted through the apertures 338, 348 to fasten the jack plate 330 to the top plate 344A. The top plate 344A and the first and second tabs 335, 337 may be configured so that the top plate is received between upper surfaces of the tabs and the lower surface of the base 332 of the jack plate 330 with little or no (that is, insubstantial) play.

As shown, the outer tube 322 of the jack 320 may be proximate or in abutment with a rear portion of the jack-receiving aperture 345 when the first and second flanges 331, 333 and first and second tabs 335, 337 are oriented for passage through the first and second slots 347, 349, respectively, and the jack may be pitched forward so that the outer tube is proximate or abuts a forward portion of the aperture 345 in order to engage the tabs with the lower surface of the top plate 344A, as discussed above. The jack 320 may be pitched in the opposite direction to disengage the first and second tabs 335, 337 from the top plate 334A.

In an embodiment wherein the first and second tabs 335, 337 extend laterally outwardly from the first and second flanges 331, 333, respectively, the jack 320 may be manipulated as described above in connection with the embodiment shown to engage and disengage the first and second tabs with and from the top plate 344A.

In an embodiment wherein the first and second tabs 335, 337 extend rearwardly from the first and second flanges 331, 333, respectively, the jack 320 may be manipulated in a manner opposite to that described above in connection with the embodiment to engage and disengage the first and second tabs with and from the top plate 344A.

Various embodiments having various features have been described herein in detail. Features of a given embodiment may be incorporated into other embodiments to the greatest extent possible. The embodiments shown and described herein are illustrative and are not intended to limit the scope of the invention as defined by the appended claims.

1. A system for use in connecting a tongue jack comprising an outer tube to a tongue of a trailer, the system comprising:
a coupler configured for connection to an upper portion of the tongue of the trailer, the coupler having a coupler plate defining a coupler aperture configured to receive the outer tube, the coupler aperture configured to allow substantial lateral fore-and-aft motion of the outer tube with respect to the coupler and to substantially preclude lateral side-to-side motion of the outer tube with respect to the coupler, the coupler plate further defining a first slot and a second slot;
a lower plate configured for connection to a lower portion of the tongue of the trailer, the lower plate defining a lower plate aperture configured to receive and substantially preclude lateral motion of the outer tube of the tongue jack; and
a jack plate defining an aperture configured to receive the outer tube of the tongue jack, the jack plate comprising a base, a first flange extending from the base, a first tab extending from the first flange, a second flange extending from the base, and a second tab extending from the first flange;
wherein the first slot is configured to selectively receive the first flange and the first tab therein, wherein the second slot is configured to selectively receive the second flange and the second tab therein, and wherein the coupler is configured to selectively retain the jack plate in engagement therewith.

2. The system of claim 1, wherein the first slot is configured to receive the first flange and the first tab when the outer tube is in a first fore-and-aft position with respect to the coupler, and wherein the second slot is configured to receive the second flange and the second tab when the outer tube is in the first fore-and-aft position with respect to the coupler.

3. The system of claim 2 where the first slot is configured to receive the first flange but not the first tab when the outer tube is in a second fore-and-aft position with respect to the coupler, and wherein the second slot is configured to receive the second flange but not the second tab when the outer tube is in the second fore-and-aft position with respect to the coupler.

4. The system of claim 3 wherein the jack plate is configured to receive the coupler plate between the base and the first tab and between the base and the second tab when the outer tube is in the second fore-and-aft position with respect to the coupler.

5. The system of claim 4 wherein the first tab extends forwardly from the first flange and the second tab extends forwardly from the second flange.

6. The system of claim 4 wherein the first tab extends rearwardly from the first flange and the second tab extends rearwardly from the second flange.

7. The system of claim 4 wherein the first tab extends outwardly from the first flange and the second tab extends outwardly from the second flange.

8. A trailer frame comprising:
a tongue jack comprising an outer tube and a jack plate having a base, a first flange extending from the base, a first tab extending from the first flange, a second flange extend form the base, and a second tab extending from the second flange;
a coupler connected to an upper portion of a tongue of the trailer frame, the coupler having a coupler plate defining a coupler aperture configured to receive the outer tube, the coupler aperture configured to allow substantial lateral fore-and-aft motion of the outer tube with respect to the coupler and to substantially preclude lateral side-to-side motion of the outer tube with respect to the coupler, the coupler plate further defining a first slot and a second slot; and
a lower plate connected to a lower portion of the tongue of the trailer, the lower plate defining a lower plate aperture configured to receive and substantially preclude lateral motion of the outer tube;
wherein the coupler and the jack plate are configured so that:
the first flange and the first tab may be received within the first slot and the second flange and the second tab may be received within the second slot when the jack is in a first fore-and-aft position with respect to the coupler aperture,
the first flange but not the first tab may be received within the first slot and the second flange but not the second tab may be received within the second slot when the jack is in a second fore-and-aft position with respect to the coupler aperture; and
the first tab and the second tab selectively are in bearing engagement with the coupler when the jack is in the second fore-and-aft position with respect to the coupler aperture.

9. The trailer frame of claim 8 wherein the outer tube is received within the lower plate aperture and within the coupler aperture.

10. The trailer frame of claim 9 wherein the outer tube is received within the coupler aperture in the second fore-and-aft position and the first tab and the second tab are in bearing engagement with the coupler.

11. The trailer frame of claim 10 further comprising a fastener securing the jack plate to the coupler plate.

12. The trailer frame of claim 8 wherein the first tab extends forwardly from the first flange and the second tab extends forwardly from the second flange.

13. The system of claim 8 wherein the first tab extends rearwardly from the first flange and the second tab extends rearwardly from the second flange.

14. The system of claim 8 wherein the first tab extends outwardly from the first flange and the second tab extends outwardly from the second flange.

15. A method of connecting a tongue jack to a trailer frame comprising the steps of:
providing a trailer frame;
providing a tongue jack comprising an outer tube and a jack plate having a base, a first flange extending from the base, a first tab extending from the first flange, a second flange extending from the base, and a second tab extending from the second flange;
providing a coupler having a coupler plate defining a coupler aperture configured to receive the outer tube, the coupler aperture configured to allow substantial lateral fore-and-aft motion of the outer tube with respect to the coupler and to substantially preclude lateral side-to-side motion of the outer tube with respect to the coupler, the coupler plate further defining a first slot and a second slot;
providing a lower plate defining a lower plate aperture configured to receive and substantially preclude lateral motion of the outer tube;
connecting the coupler to an upper portion of a tongue of the trailer frame;
connecting the lower plate to a lower portion of the tongue of the trailer;
inserting the outer tube through the coupler aperture;
inserting the outer tube through the lower plate aperture;
with the outer tube in a first fore-and-aft position with respect to the coupler aperture, inserting the first flange and the first tab through the first slot;
with the outer tube in the first fore-and-aft position with respect to the coupler aperture, inserting the second flange and the second tab through the second slot; and
manipulating the outer tube to a second fore-and-aft position with respect to the coupler aperture, wherein the coupler plate is engaged between the base of the jack plate and the first and second tabs of the jack plate.

16. The method of claim 15 further comprising the step of securing the jack plate to the coupler plate.

17. The method of claim 16 further comprising the step of securing the jack plate to the coupler plate using a mechanical fastener engaged with corresponding apertures defined by the jack plate and the coupler plate.

18. A trailer frame comprising:
a tongue jack having an outer tube and a jack plate having a hanger including a stem and at least one tab extending from the stem;
a coupler connected to one of an upper portion and a lower portion of a tongue of the trailer frame;
a plate connected to the other of an upper portion and a lower portion of the tongue of the trailer frame;
one of the coupler and the plate defining a slot extending inwardly from an edge thereof; and
the other of the coupler and the plate defining an aperture;
wherein the outer tube and the stem are received within the slot defined by the one of the coupler and the plate, the stem is supported by the one of the coupler and the plate, and the jack plate is in bearing engagement with the one of the coupler and the plate; and
wherein the outer tube is received within the aperture defined by the other of the coupler and the plate and is laterally restrained by the other of the coupler and the plate.

19. The trailer frame of claim 18 wherein the coupler defines the slot and is attached to the upper portion of the trailer frame; and
wherein the plate defines the aperture and is attached to the lower portion of the trailer frame.

20. The trailer frame of claim 18 wherein the plate defines the slot and is attached to the upper portion of the trailer frame; and
wherein the coupler defines the aperture and is attached to the lower portion of the trailer frame.
